(19) United States
(12) Patent Application Publication
(10) Pub. No.: US 2007/0206699 A1
(43) Pub. Date: Sep. 6, 2007

(54) Adaptive space-time coding and modulation method and transmitter

(76) Inventors: Chunlin Yan, Beijing (CN); Zhan Zhang, Beijing (CN); Hidetoshi Kayama, Beijing (CN)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/713,230

(22) Filed: Mar. 1, 2007

(30) Foreign Application Priority Data
Mar. 1, 2006 (CN) 200610057841.1

(51) Int. Cl. H04L 1/02

(52) U.S. Cl. 375/267

(57) ABSTRACT

Embodiments of the present invention provides an adaptive space-time coding and modulation method and a transmitter. In one embodiment, the method includes: obtaining a curve corresponding to a modulation mode, a channel coding rate, a coding mode of a space-time code, a parameter indicating signal transmission quality and SNR by simulating or measuring at transmit-side and making a table with correspondences between the SNR, the modulation mode and the coding mode of the space-time code according to a SNR range corresponding to a predefined signal transmission quality. Higher frequency spectrum efficiency can be achieved with the quality of service guaranteed.

### PRIORITY

The present application claims priority to and incorporates by reference the entire contents of Chinese priority document 200610057841.1, filed in China on Mar. 1, 2006.

### FIELD OF THE INVENTION

The present invention relates to wireless communication technology and more particularly to an adaptive space-time coding and modulation method and a transmitter.

### BACKGROUND OF THE INVENTION

Adaptive modulation is a kind of modulation, that can adaptively change modulation modes according to channel conditions. For example, BPSK is used when SNR is low and QPSK, 16 QAM and 64 QAM may be respectively used when SNR increases gradually. A high-order modulation may contribute to system data transmission rate and improves system spectrum efficiency.

In order to guarantee system robustness when using a high-order modulation, adaptive channel coding may be further adopted such as adding Turbo code with a code rate of ½ or ¾. After adopting the adaptive channel coding, since the code rate is less than 1, the data transmission efficiency is reduced while the robustness of data transmission is greatly improved. In a time-varying and multi-path fading wireless communication channel, a robust data transmission is of great importance.

As discussed above, since the adaptive coding and modulation can improve the robustness of the data transmission and data transmission efficiency of the system, the adaptive coding and modulation has become one of the most important parts in modern communication system.

In addition, as a trend of modern communication technology, MIMO technology can greatly improve system capacity or reduce bit error rate (BER) of the data transmission while enhancing the performance of the wireless communication system. In a communication system using MIMO, the adaptive coding and modulation can also improve its data transmission rate and robustness. The space-time codes adopted by the MIMO system are mainly of two types: one with diversity gain and the other with multiplexing gain.

The principle of the space-time code is to obtain certain space diversity and time diversity with help of the space code and time code in order to reduce the BER. The architecture of the space-time code adopted by the adaptive code modulation of the existing MIMO system is fixed. Generally, the space-time code selects a space-time block code (STBC) in order to obtain the diversity gain or selects a vertical-bell labs space-time (VBLAST) architecture in order to obtain the multiplexing gain. Then the adaptive modulation is adopted to further improve the data transmission rate and robustness.

However, in the MIMO system, when the SNR is relatively low, the diversity gain is of great importance in obtaining a small spectrum efficiency while guaranteeing a certain signal transmission quality, and the space-time code with large diversity gain will help in achieving a better system performance; when the SNR is relatively high, the multiplexing gain is more advantageous and the space-time code with large multiplexing gain will play an important role. Therefore, if the space-time code with a fixed architecture is simply combined with the adaptive coding and modulation, the better effect cannot be achieved.

Recently, a space-time code with both multiplexing gain and diversity gain is proposed. The multiplexing-diversity gain is adjustable and the space-time code can achieve tradeoff between multiplexing and diversity. Generally the adaptive coding and modulation using this space-time code only modulates external code rate (such as a Turbo code and LDPC code) and modulation modes (BPSK, QPSK, 16 QAM) while the architecture of the space-time code is fixed, a better system performance cannot be achieved.

### SUMMARY OF THE INVENTION

An adaptive space-time coding and modulation method and transmitter are described. In one embodiment, an adaptive space-time coding and modulation method, comprises obtaining a curve corresponding to a modulation mode, a coding mode of a space-time code, a parameter indicating signal transmission quality and a SNR by simulating or measuring at transmit-side and making a table with correspondences between the SNR, the modulation mode and the coding mode of the space-time code according to a SNR range corresponding to a predefined signal transmission quality, or obtaining a curve corresponding to a modulation mode, a channel coding rate, a coding mode of a space-time code, a parameter indicating signal transmission quality and a SNR by simulating or measuring at transmit-side and making a table with correspondences between the SNR, the modulation mode, the channel coding rate and the coding mode of the space-time code according to a SNR range corresponding to a predefined signal transmission quality; obtaining the SNR at receive-side by measurement or feedback channel, comparing the obtained SNR with the SNR range according to the table and selecting corresponding modulation mode and coding mode of the space-time code or selecting corresponding modulation mode, channel coding rate and coding mode of the space-time code; and performing signal modulation and space-time coding or performing signal modulation, channel coding and space-time coding according to the selected results.

### BRIEF DESCRIPTION OF THE DRAWINGS

FIG. 1 is a schematic diagram showing the architecture of a transmitter according to an embodiment of the present invention;

FIG. 2 is a curve diagram obtained by simulations according to an embodiment of the present invention showing a performance of a 4×4 MIMO system;

FIG. 3 is a schematic diagram showing a comparison of performance between the adaptive modulation method of an embodiment of the present invention and a traditional method with a same SNR; and

FIG. 4 is a schematic diagram showing a comparison of SNR-frequency efficiency performance between the adaptive modulation method of an embodiment of the present invention and a traditional method.

### DETAILED DESCRIPTION OF THE INVENTION

Embodiments of the present invention include a method and device, that can achieve a higher frequency spectrum efficiency and a better system robustness by adjusting a coding mode of the space-time code.

According to one embodiment of the present invention, an adaptive space-time coding and modulation method is provided, which includes: obtaining a curve corresponding to a modulation mode, a coding mode of a space-time code, a parameter indicating signal transmission quality and a SNR by simulating or measuring at transmit-side and making a table with correspondences among the SNR, the modulation mode, channel code rate and the coding mode of the space-time code according to a SNR range corresponding to a predefined signal transmission quality, or obtaining a curve corresponding to a modulation mode, a channel coding rate, a coding mode of a space-time code, a parameter indicating signal transmission quality and a SNR by simulating or measuring at transmit-side and making a table with correspondences between the SNR, the modulation mode, the channel coding rate and the coding mode of the space-time code according to a SNR range corresponding to a predefined signal transmission quality; obtaining the SNR at receive-side by measurement or feedback channel, comparing the obtained SNR with the SNR range according to the table and selecting corresponding modulation mode and coding mode of the space-time code or selecting corresponding modulation mode, channel coding rate and coding mode of the space-time code; and performing signal modulation and space-time coding or performing signal modulation, channel coding and space-time coding according to the selected results.

According to another embodiment of the present invention, a transmitter includes: a table-making module, for obtaining a curve corresponding to a modulation mode, a coding mode of a space-time code, a parameter indicating signal transmission quality and a SNR by simulating or measuring at the transmitter and making a corresponding table taking into account the SNR, the modulation mode and the coding mode of the space-time code according to a SNR range and the predefined signal transmission quality, or obtaining a corresponding curve with taking into account modulation mode, channel coding rate, coding mode of a space-time code, parameter indicating signal transmission quality and SNR by simulating or measuring at the transmitter and making a corresponding table; an obtaining and selecting module, for obtaining the SNR at receiver by measurement or feedback channel, comparing the obtained SNR with the SNR range according to the table and selecting corresponding modulation mode and coding mode of the space-time code or selecting corresponding modulation mode, channel coding rate and coding mode of the space-time code; and a coding and modulation module, for performing signal modulation and space-time coding or performing signal modulation, channel coding and space-time coding according to the selected results.

The advantageous effect of the present invention is that according to the adaptive coding and modulation method and the transmitter of the present invention, the system spectrum efficiency can be improved by optimizing the architecture of the space-time code and thus a higher frequency efficiency and a better system robustness can be obtained. In addition, the table may be dynamically adjusted according to the feedback from the receiver and the adaptive coding and modulation may be performed more flexibly.

Embodiments of the present invention provide an adaptive coding and modulation method combined with space-time coding for a MIMO system and a transmitter using thereof.

The adaptive coding and modulation method mainly combines the modulation mode with the space-time coding or combines the modulation mode, channel coding and space-time coding together and adjusts the above two combinations in order to obtain higher frequency spectrum efficiency and better system robustness.

The difference from the existing space-time coding is that the adaptive coding and modulation method according to an embodiment of the present invention uses a well known space-time code whose per channel use (PCU) is adjustable, such as the linear dispersion space-time code (LD code), threaded algebra space-time code (TAST) and other space-time code, but the architecture of the space-time code changes with the change of the channel. Therefore, when using the same space-time code (only the architecture changes with change of the channel), since the decoding method is the same as the existing one, the complexity of the receiver can be further reduced and there is no need to design two decoding methods (space-time code block and VBLAST).

Next, before explaining the adaptive coding and modulation method and the transmitter according to one embodiment of the present invention in detail, the threaded algebra space-time code (TAST) is taken as an example to explain the coding mode (architecture change) of the space-time code in the present invention.

The coding rate of the space-time code is defined as the number of the symbols transmitted in each slot by each antenna and can also be described by the PCU. When the coding rate is 1, the coding matrix of the threaded algebra space-time code (TAST) is:

$$( \begin{matrix}{s}_{1} & {ϕ}^{3 / 4} {s}_{4} & {ϕ}^{2 / 4} {s}_{3} & {ϕ}^{1 / 4} {s}_{2} \\ {ϕ}^{1 / 4} {s}_{2} & {s}_{1} & {ϕ}^{3 / 4} {s}_{4} & {ϕ}^{2 / 4} {s}_{3} \\ {ϕ}^{2 / 4} {s}_{3} & {ϕ}^{1 / 4} {s}_{2} & {s}_{1} & {ϕ}^{3 / 4} {s}_{4} \\ {ϕ}^{3 / 4} {s}_{4} & {ϕ}^{2 / 4} {s}_{3} & {ϕ}^{1 / 4} {s}_{2} & {s}_{1}\end{matrix} )$$

In the above matrix, φ is a Diophantine number for guaranteeing the full diversity of the space-time code. This coding matrix transmits symbols S₁˜S₄ (4 symbols) in four time slots.

When the coding rate is 2, the coding matrix is:

$$( \begin{matrix}{s}_{11} & {ϕ}^{3 / 4} {s}_{42} & {ϕ}^{2 / 4} {s}_{31} & {ϕ}^{1 / 4} {s}_{22} \\ {ϕ}^{1 / 4} {s}_{21} & {s}_{12} & {ϕ}^{3 / 4} {s}_{41} & {ϕ}^{2 / 4} {s}_{32} \\ {ϕ}^{2 / 4} {s}_{31} & {ϕ}^{1 / 4} {s}_{22} & {s}_{11} & {ϕ}^{3 / 4} {s}_{42} \\ {ϕ}^{3 / 4} {s}_{41} & {ϕ}^{2 / 4} {s}_{32} & {ϕ}^{1 / 4} {s}_{21} & {s}_{12}\end{matrix} )$$

This coding matrix transmits symbols S₁₁˜S₄₂ (8 symbols) in four time slots.

When the coding rate is 3, the coding matrix is:

$$( \begin{matrix}{s}_{11} & {ϕ}^{3 / 4} {s}_{42} & {ϕ}^{2 / 4} {s}_{33} & {ϕ}^{1 / 4} {s}_{24} \\ {ϕ}^{1 / 4} {s}_{21} & {s}_{12} & {ϕ}^{3 / 4} {s}_{43} & {ϕ}^{2 / 4} {s}_{34} \\ {ϕ}^{2 / 4} {s}_{31} & {ϕ}^{1 / 4} {s}_{22} & {s}_{13} & {ϕ}^{3 / 4} {s}_{44} \\ {ϕ}^{3 / 4} {s}_{41} & {ϕ}^{2 / 4} {s}_{32} & {ϕ}^{1 / 4} {s}_{23} & {s}_{14}\end{matrix} )$$

Where (sᵢ₁,sᵢ₂,sᵢ₃,sᵢ₄)=M(uᵢ₁,uᵢ₂,uᵢ₃,0), i=1,2,3,4. M is the rotation matrix with dimension 4×4 and uᵢ₁ is the modulated symbol. This coding matrix transmits symbols S₁₁˜S₄₂ (12 symbols) in four time slots.

When the coding rate is 4, the coding matrix is:

$$( \begin{matrix}{s}_{11} & {ϕ}^{3 / 4} {s}_{42} & {ϕ}^{2 / 4} {s}_{33} & {ϕ}^{1 / 4} {s}_{24} \\ {ϕ}^{1 / 4} {s}_{21} & {s}_{12} & {ϕ}^{3 / 4} {s}_{43} & {ϕ}^{2 / 4} {s}_{34} \\ {ϕ}^{2 / 4} {s}_{31} & {ϕ}^{1 / 4} {s}_{22} & {s}_{13} & {ϕ}^{3 / 4} {s}_{44} \\ {ϕ}^{3 / 4} {s}_{41} & {ϕ}^{2 / 4} {s}_{32} & {ϕ}^{1 / 4} {s}_{23} & {s}_{14}\end{matrix} )$$

Where (sᵢ₁,sᵢ₂,sᵢ₃,sᵢ₄)=M(uᵢ₁,uᵢ₂,uᵢ₃,uᵢ₄), i=1,2,3,4.

This coding matrix transmits symbols S₁₁˜S₄₄(16 symbols) in four time slots.

In order to obtain a higher spectrum efficiency while guaranteeing the signal transmission quality, since the diversity is of a dominating factor when the SNR is relatively low, the coding can select a relatively small PCU; when the SNR increases gradually, the multiplexing becomes more and more important and the value of the PCU can be increased gradually. Therefore, the space-time coding mode according to one embodiment of the present invention can adjust the data transmission rate of the system by adjusting the per channel use (PCU) of space time codes.

### Embodiment 1

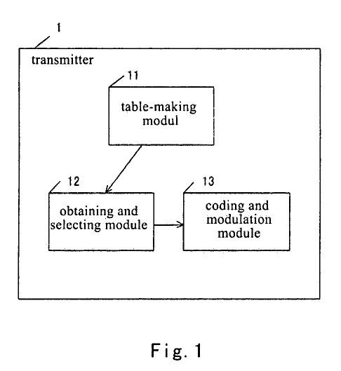

FIG. 1 is a schematic diagram showing the architecture of a transmitter 1 according to an embodiment of the present invention.

FIG. 1 shows transmitter 1 in embodiment 1 includes a table-making module 11, an obtaining and selecting module 12, a coding and modulation module 13.

The table-making module 11 obtains a curve corresponding to a modulation mode, a coding mode of a space-time code, a parameter indicating signal transmission quality and a SNR by simulations or measurement at the transmitter in order to get a SNR range guaranteeing the predefined signal transmission quality; and makes a table with correspondences between the SNR, the modulation mode and the coding mode of the space-time code according to the SNR range corresponding to a predefined signal transmission quality.

The parameter indicating signal transmission quality includes a bit error rate (BER), a frame error rate, or a block error rate, etc. The SNR range can be set freely according to the practical communication requirements.

The obtaining and selecting module 12 obtains the SNR at the receiver by measuring a channel status or through a feedback channel (SNR fed back by the receiver), compares the obtained SNR with the SNR range according to the table made by the table-making module 11, and selects the corresponding modulation mode and coding mode of the space-time code if the obtained SNR is within a SNR range.

The coding and modulation module 13 performs the signal modulation and space-time coding according to the results from the obtaining and selecting module 12.

At the same time, the table-making module 11 and the obtaining and selecting module 12 send the table and the selection results to the receiver respectively so that the receiver can demodulate and decode signals with the existing demodulation and decoding technologies which will not be described in detail here.

An example will be given in explaining how the table-making module 11 makes the table.

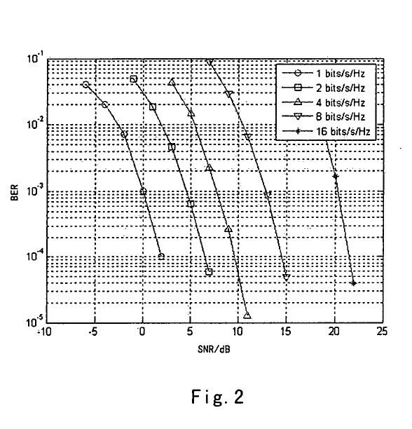

FIG. 2 is a simulation curve diagram obtained by the table-making module 11 in a 4×4 MIMO system, which corresponds to the modulation mode, coding mode of the space-time code, parameter indicating the signal transmission quality and SNR. The horizontal axis represents the SNR and the vertical axis represents the bit error rate (BER).

At this time, the table-making module 11 may select 2 dB, 6.5 dB, 9.6 dB, 14.5 dB, 21.5 dB (other number can also be selected) as the SNR thresholds with the principle of BER=10⁻⁴ based on an actual communication requirement. In the simulation curve of FIG. 2, according to the simulation curve in accordance with the BER=10⁻⁴ and the SNR thresholds, the corresponding modulation mode and the coding mode of the space-time code (the PCU of the space-time coding) can be obtained and thus a table represented by table 1 can be obtained.

Herein, the cross point (SNR value, 2 dB etc.) of the horizontal line of BER=10⁻⁴ with the simulation curve is selected as the SNR threshold. Of course, the SNR threshold can be set according to the experience in communications.

TABLE 1
Table Made by Table-making Module 11 According
to Embodiment 1 of Present Invention

| | SNR Range (dB) | | | | |
|---|---|---|---|---|---|
| | 2 < | 6.5 < | 9.6 < | 14.5 < | |
| | SNR ≦ | SNR ≦ | SNR ≦ | SNR ≦ | 21.5 < |
| | 6.5 | 9.6 | 14.5 | 21.5 | SNR |
| Modulation Mode | BPSK | QPSK | QPSK | QPSK | 16QAM |
| Per Channel Use of | 1 | 1 | 2 | 4 | 4 |
| Space-time Coding | | | | | |
| (PCU) | | | | | |
| Frequency Spectrum | 1 | 2 | 4 | 8 | 16 |
| Efficiency | | | | | |
| (bits/s/Hz) | | | | | |

Table 1 shows in the embodiment 1, both the coding mode of the space-time code and the modulation mode are changing adaptively with the change of the SNR. For example, a space-time code with a low PCU (per channel use) is selected when the SNR is low in order to obtain a good BER performance; the PCU of the space-time code is increased when the SNR is relatively high in order to improve the frequency spectrum use ratio of the system so that a high frequency spectrum efficiency can be obtained under the prerequisite of guaranteeing a certain signal transmission quality.

### Embodiment 2

The architecture of the transmitter according to embodiment 2 of the present invention is similar to that of the embodiment 1, including a table-making module 11, an obtaining and selecting module 12 and a coding and modulation module 13.

The table-making module 11 obtains a curve corresponding to a modulation mode, a coding mode of the space-time code, a parameter indicating signal transmission quality and a SNR by simulation or measurement at the transmitter in order to get a SNR range guaranteeing the predefined signal transmission quality; and makes a table with correspondences between the SNR, the modulation mode, the channel coding rate and the coding mode of the space-time code according to a SNR range corresponding to a predefined signal transmission quality. Herein, the parameter indicating signal transmission quality includes bit error rate, frame error rate, or bit error rate, etc. The channel coding rate is the one of the external code (such as the Turbo code and LDPC code).

The obtaining and selecting module 12 obtains the SNR at the receiver by measuring a channel status or through a feedback channel, compares the obtained SNR with the SNR range according to the table made by the table-making module 11, and selects the corresponding modulation mode, channel coding rate and coding mode of the space-time code if the obtained SNR is within a SNR range.

The coding and modulation module 13 performs the signal modulation, channel coding and space-time coding according to the selection results from the obtaining and selecting module 12.

At the same time, the table-making module 11 and the obtaining and selecting module 12 send the table and the selection result to the receiver respectively so that the receiver can demodulate and decode signals with the existing demodulating and decoding technologies which will not be described in detail here.

Table 2 shows an example of a table made by the table-making module 11 according to the embodiment 2 of the present invention.

In a 4×4 MIMO system, the table-making module 11 designs a table after simulation or practical measurement with the BER of 10⁻³.

TABLE 2
Table Made by Table-making Module 11 According to Embodiment 2 of Present Invention

| | SNR Range (dB) | | | | | | | | |
|---|---|---|---|---|---|---|---|---|---|
| | SNR ≦ | 0 < | 2 < | 3 < | 4 < | 5 < | 6 < | 9 < | 10 < |
| | 0 | SNR ≦ 2 | SNR ≦ 3 | SNR ≦ 4 | SNR ≦ 5 | SNR ≦ 6 | SNR ≦ 9 | SNR ≦ 10 | SNR |
| Modulation | BPSK | QPSK | QPSK | QPSK | QPSK | QPSK | QPSK | 16QAM | 16QAM |
| Mode | | | | | | | | | |
| Channel | 1/2 | 1/2 | 2/3 | 1/2 | 2/3 | 1/2 | 2/3 | 1/2 | 2/3 |
| coding rate | | | | | | | | | |
| Per Channel | 1 | 1 | 1 | 2 | 2 | 4 | 4 | 4 | 4 |
| Use of | | | | | | | | | |
| Space-time | | | | | | | | | |
| Coding (PCU) | | | | | | | | | |
| Frequency | 0.5 | 1 | 4/3 | 2 | 8/3 | 4 | 16/3 | 8 | 32/3 |
| Spectrum | | | | | | | | | |
| Efficiency | | | | | | | | | |
| bits/s/Hz | | | | | | | | | |

According to Table 2, if the SNR obtained by the obtaining and selecting module 12 by measuring or through the feedback channel is 8 dB, then the modulation mode is QPSK, channel coding rate is ⅔, PCU of the space-time code is 4 according to the table. The corresponding frequency spectrum efficiency can be achieved is 16/3 bits/s/Hz at this time.

In the embodiment, since the rate of the channel coding is also adjustable, the adaptive coding and modulation method of the present invention has a good flexibility.

Table 2 shows that in the embodiment 2, not only the modulation mode, but the channel coding rate and the coding mode of the space-time code are changing adaptively with the change of the SNR. For example, proper change of channel coding rate will help to obtain a lower frequency spectrum efficiency while guaranteeing signal transmission quality. The diversity is of a dominating importance when the SNR is relatively low, a relatively small PCU and small modulation order can be selected; when the SNR increases, the multiplexing becomes more and more important so the value of the PCU can be increased gradually and a proper modulation order can be selected in order to obtain a better BER performance and data transmission rate (herein, BPSK is a low order modulation mode and 16 QAM is a high-order modulation mode); when the PCU reaches the maximum value, the modulation order may be adjusted to increase the data transmission rate, to obtain a higher spectrum efficiency while guaranteeing a certain signal transmission quality, so that a good system robustness and a more flexible adaptive coding and modulation can be realized.

### Embodiment 3

The architecture of the transmitter according to the embodiment 3 of the present invention is similar to that of the embodiment 1 and of the embodiment 2, including a table-making module 11, an obtaining and selecting module 12 and a coding and modulation module 13.

Similarly with that in embodiment 1 and 2, the table-making module 11 firstly makes a table with correspondences among the SNR, the modulation mode and the coding mode of the space-time code, or makes a table with correspondences between the SNR, the modulation mode, the channel coding rate and the coding mode of the space-time code.

The obtaining and selecting module 12 obtains the SNR by measuring a channel status or through a feedback channel and selects the modulation mode and the coding mode of the space-time code corresponding to a SNR range, or selects the modulation mode, channel coding rate and the coding mode of the space-time code corresponding to a SNR range.

The coding and modulation module 13 performs the signal modulation and the space-time coding or performs the signal modulation, channel coding and space-time coding according to the selection result from the obtaining and selecting module 12.

At the same time, the table-making module 11 and the obtaining and selecting module 12 send the table and the selection results to the receiver respectively so that the receiver can demodulate and decode signals with the existing demodulating and decoding technologies.

Different from that in embodiments 1 and 2, after demodulation and decoding according to the table and selection results from the transmitter, if the receiver cannot obtain the signal transmission quality (such as BER) as the principle of making the table it feeds back the parameters that are acquired by the demodulation and decoding and are indicating the signal transmission quality to the transmitter.

The table-making module 11 in the transmitter re-adjusts the table or re-performs the selection according to the feedback information from the receiver.

For example, the table-making module 11 makes the table with principle of BER=10⁻³. Then the table-making module 11 and the obtaining and selecting module 12 send the table and the selection result (for example, corresponding to 5 dB) to the receiver. When the receiver demodulates and decodes the received signals, it obtains the BER of 10⁻², then the receiver feeds back the information such as the BER of 10⁻² and the SNR (currently 4dB) to the transmitter. The table-making module 11 in the transmitter changes the modulation mode etc. in the table corresponding to the SNR (4 dB) fed back by the receiver, i.e. changes the modulation mode (reduces the modulation mode order such as from QPSK to BPSK) and/or changes the coding mode of the space-time code (reduces the PCU of the space-time code).

It should be noted that if the BER acquired by the receiver is not larger than 10⁻³, the transmitter doesn't need to adjust the table dynamically.

Thus the transmitter according to embodiment 3 can dynamically adjust the table and perform the adaptive coding modulation more flexibly.

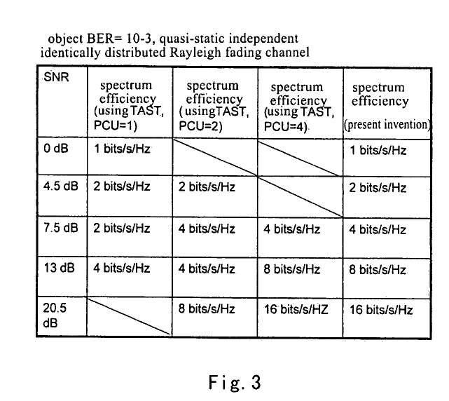

FIG. 3 is a schematic diagram showing a comparison of performance between the adaptive modulation method of the present invention and a traditional method. In FIG. 3, it is assumed that the traditional adaptive modulation method adopts the TAST space-time code with a fixed architecture (PCU=1, PCU=2, PCU=4 respectively), the object BER is 10⁻³ and the channel is a quasi-static independent identically distributed Rayleigh fading channel. Accordingly, the performance comparison between the adaptive modulation method used by the transmitter in embodiment 1 and the traditional method shows when the SNRs are the same respectively, the embodiments of the present invention gets a higher frequency spectrum efficiency (the slash line means the traditional method cannot work).

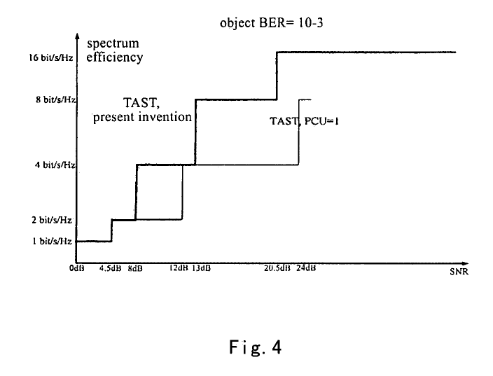

FIG. 4 is a schematic diagram showing a comparison between the adaptive modulation method of the present invention and a traditional method. In FIG. 4, it is assumed that the traditional adaptive modulation method adopts the TAST space-time code with a fixed architecture (PCU=1). Accordingly, the performance comparison between the adaptive modulation method used by the transmitter in embodiment 1 and the traditional method shows when the SNRs are the same respectively, the present invention gets a higher frequency spectrum efficiency; or when the frequency spectrum efficiencies are the same respectively, the embodiments of the present invention gets a lower SNR.

According to the adaptive coding and modulation method of the present invention and the transmitter using thereof, the spectrum efficiency of the system can be improved while a certain signal transmission quality is guaranteed by optimizing the architecture of the space-time code and thus a higher frequency efficiency and a better system robustness can be obtained. In addition, the table may be dynamically adjusted according to the feedback from the receiver and the adaptive coding and modulation may be performed more flexibly.

Although illustrative embodiments have been described herein with reference to the accompanying drawings, it is to be understood by those skilled in the art that the present invention is not limited to those preferred embodiments, and that various changes and modifications can be made therein without departing from the spirit and the scope of the invention. Thus, it is intended that the present invention covers the modifications and variations of this invention provided they come within the scope of the appended claims and their equivalents.

1. An adaptive space-time coding and modulation method, comprising steps of:
obtaining a curve corresponding to a modulation mode, a coding mode of a space-time code, a parameter indicating signal transmission quality and a SNR by simulating or measuring at transmit-side and making a table with correspondences between the SNR, the modulation mode and the coding mode of the space-time code according to a SNR range corresponding to a predefined signal transmission quality, or
obtaining a curve corresponding to a modulation mode, a channel coding rate, a coding mode of a space-time code, a parameter indicating signal transmission quality and a SNR by simulating or measuring at transmit-side and making a table with correspondences between the SNR, the modulation mode, the channel coding rate and the coding mode of the space-time code according to a SNR range corresponding to a predefined signal transmission quality;
obtaining the SNR at receive-side by measurement or feedback channel, comparing the obtained SNR with the SNR range according to the table and selecting corresponding modulation mode and coding mode of the space-time code or selecting corresponding modulation mode, channel coding rate and coding mode of the space-time code; and
performing signal modulation and space-time coding or performing signal modulation, channel coding and space-time coding according to the selected results.

2. The adaptive space-time coding and modulation method according to claim 1, wherein
the parameter indicating the signal transmission quality comprises a bit error rate, a frame error rate, a block error rate or other parameters that can reflect the quality of the transmit signal;
per channel use (PCU) of the space-time code is adjustable and the space-time code comprises a linear dispersion space-time code (LD code), a threaded algebra space-time code (TAST) or another space-time code whose PCU is adjustable.

3. The adaptive space-time coding and modulation method according to claim 2, wherein
the coding mode of the space-time code is not fixed and the per channel use changes with the variant of the channel in order to achieve high spectrum efficiency with quality of service guaranteed.

4. The adaptive space-time coding and modulation method according to claim 3, wherein
in the table, if second SNR value is larger than first SNR value, per channel use and/or modulation mode order and/or channel coding rate corresponding to the second SNR is higher than per channel use and/or modulation mode order and/or channel coding rate corresponding to the first SNR.

5. The adaptive space-time coding and modulation method according to any of claims 1-4, further comprising,
transferring the table and the selecting results from the transmit-side to the receive-side for demodulating and decoding received signals,
and when detecting that the predefined signal transmission quality cannot be satisfied at the receive-side, feeding detection result back to the transmit-side and re-obtaining the SNR at receive-side, comparing the obtained SNR with the SNR range and performing the selection, or adjusting the table by using lower modulation mode and/or reducing the per channel use of the space-time code.

6. A transmitter, comprising:
a table-making module, for obtain a curve corresponding to a modulation mode, a coding mode of a space-time code, a parameter indicating signal transmission quality and a SNR by simulating or measuring at the transmitter and making a corresponding table taking into account the SNR, the modulation mode and the coding mode of the space-time code according to a SNR range and the predefined signal transmission quality, or obtain a corresponding curve with taking into account modulation mode, channel coding rate, coding mode of a space-time code, parameter indicating signal transmission quality and SNR by simulating or measuring at the transmitter and making a corresponding table;
an obtaining and selecting module, to obtain the SNR at receiver by measurement or feedback channel, comparing the obtained SNR with the SNR range according to the table and selecting corresponding modulation mode and coding mode of the space-time code or selecting corresponding modulation mode, channel coding rate and coding mode of the space-time code; and
a coding and modulation module, to perform signal modulation and space-time coding or performing signal modulation, channel coding and space-time coding according to the selected results.

7. The transmitter according to claim 6, wherein
the parameter indicating the signal transmission quality comprises a bit error rate, a frame error rate, a block error rate or other parameters that can reflect the quality of the transmit signal;
per channel use of the space-time code is adjustable and the space-time code comprises a linear dispersion space-time code (LD code), a threaded algebra space-time code (TAST) or another space-time code whose per channel use is adjustable.

8. The transmitter according to claim 7, wherein
the coding mode of the space-time code is not fixed and the per channel use of the space-time code changes with the channel condition, and the channel condition comprises SNR value, channel condition number of the channel

9. The transmitter according to claim 8, wherein
in the table, if second SNR value is larger than first SNR value, per channel use and/or modulation mode order corresponding to the second SNR is higher than per channel use and/or modulation mode order corresponding to the first SNR.

10. The transmitter according to one of claims 6-9, wherein
the transmitter transmits the table and the selecting results to the receiver for demodulating and decoding received signals,
and when detecting that the predefined signal transmission quality cannot be achieved at the receive-side, the receiver feeds detection result back to the transmitter and the transmitter re-obtains the SNR at receive-side, compares the obtained SNR with the SNR range and performs the selection, or adjusts the table by using lower modulation mode and/or low rate of channel code and/or reducing the per channel use of the space-time code.
